(19) United States
(12) Patent Application Publication
(10) Pub. No.: US 2026/0255163 A1
(43) Pub. Date: Aug. 27, 2026

(54) Integrated Space and Terrestrial Network

(71) Applicant: Hughes Network Systems, LLC, Germantown, MD (US)

(72) Inventor: Rajeev GOPAL, Boyds, MD (US)

(73) Assignee: Hughes Network Systems, LLC, Germantown, MD (US)

(21) Appl. No.: 19/234,233

(22) Filed: Jun. 10, 2025

Related U.S. Application Data
(60) Provisional application No. 63/763,323, filed on Feb. 26, 2025.

(51) Int. Cl. H04W 12/06; H04B 7/185; H04W 12/0431; H04W 76/10

(52) U.S. Cl. CPC H04W 12/06; H04B 7/18541; H04W 12/0431; H04W 76/10

(57) ABSTRACT

The present teachings disclose an architecture for the integration of terrestrial and space networks to enhance global connectivity for mission critical applications. The architecture utilizes Commercial Off-the-Shelf (COTS) User Equipment (UE), ensuring interoperability and security across varying domains from garrison to mission settings. In addition to commercial applications, this architectural framework is aligned with the U.S. Government’s Combined Joint All Domain Command and Control (CJADC2) to provide resilient connectivity, utilizing commercial cellular and satellite capabilities. A trusted core, Open Radio Access Network (O-RAN), and an implementation of satellite Non-Terrestrial Networks (NTN) for Direct to Device (D2D) are components for unified communication. This architecture supports a range of applications that are related to infrastructure maintenance, energy, and disaster response besides national security. Moreover, network management systems that prioritize security, resiliency, and operational efficiency are used to provide next-generation global connectivity.

### CROSS-REFERENCE TO RELATED APPLICATIONS AND INCORPORATION BY REFERENCE

The present application claims the benefit under 35 U.S.C. 119(e) of U.S. Provisional Application Ser. No. 63/763,323 filed February 26, 2025, which is incorporated herein by reference in its entirety.

### FIELD

Integrated terrestrial and satellite communications can revolutionize global connectivity for mission-critical applications. The transformative effects of this integrated approach are illustrated with specific technologies, deployment strategies, and case studies. Exemplary terrestrial communications may be based on Third-Generation Partnership Project (3GPP) technologies such as Fifth Generation (5G), Sixth Generation (6G) or better technology. Exemplary satellite communications may include Direct-to-Device (D2D) communications.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

The disclosure provides support for a method for integrating, including: integrating a satellite backhaul and a terrestrial backhaul through a trusted core to form an integrated network, authenticating a User Equipment (UE) requesting connectivity on the integrated network with the trusted core, and servicing, after the authenticating, the UE over the integrated network with seamless multi-hop connectivity, wherein the terrestrial backhaul includes a cellular Radio Access Network (RAN).

In a first example of the method, the authenticating authenticates the UE based on a Public Key Infrastructure (PKI) or a Subscriber Identity Module (SIM) received from the UE.

In a second example of the method, optionally including the first example, the UE includes one or more of an unlicensed spectrum device, a Wireless Fidelity (Wi-Fi) device, a legacy radio device, and a proprietary network device.

In a third example of the method, optionally including one or both of the first and second examples, the UE includes a Third Generation Partnership Project (3GPP) Fifth Generation (5G) technology compliant UE and the trusted core comprises a 5G compliant core.

In a fourth example of the method, optionally including one or more or each of the first through third examples, network traffic for the authenticating is communicated to the trusted core at least in part over the satellite backhaul.

In a fifth example of the method, optionally including one or more or each of the first through fourth examples, the servicing hands-off between the satellite backhaul and the terrestrial backhaul without interrupting connectivity of the UE.

In a sixth example of the method, optionally including one or more or each of the first through fifth examples, the integrated network includes at least one of a Macro cell transport, a Micro Cell transport, a Multi-access Edge Compute (MEC) transport, a 5G roaming transport, a RAN sharing transport, a 5G Sidelink transport, or an Integrated Access and Backhaul (IAB) transport.

In a seventh example of the method, optionally including one or more or each of the first through sixth examples, the method further includes: splitting the cellular RAN using an Open RAN (O-RAN) framework to distribute functions between Radio Units (RUs), Distributed Units (DUs), and Centralized Units (CUs).

In a eighth example of the method, optionally including one or more or each of the first through seventh examples, the O-RAN framework includes at least one of a 5G New Radio (NR) air interface, a 5G Core network architecture, a 5G network slicer, an O-RAN Alliance specification, an O-RAN Software Community (OSC) implementation, or an O-RAN compliant RAN architecture.

In a ninth example of the method, optionally including one or more or each of the first through eighth examples, the method further includes: managing a spectrum allocation of the satellite backhaul and the terrestrial backhaul with the trusted core.

In a tenth example of the method, optionally including one or more or each of the first through ninth examples, the trusted core includes a trusted federated 5G core.

The disclosure provides support for a system including: a trusted core to form an integrated network by integrating a satellite backhaul and a terrestrial backhaul, a User Equipment (UE) to be authenticated and to request connectivity on the integrated network with the trusted core, and wherein the integrated network services the UE with seamless multi-hop connectivity, after the UE has been authenticated, and wherein the terrestrial backhaul includes a cellular Radio Access Network (RAN).

In a first example of the system, the trusted core authenticates the UE based on a Public Key Infrastructure (PKI) or a Subscriber Identity Module (SIM) received from the UE.

In a second example of the system, optionally including the first example, the UE includes one or more of an unlicensed spectrum device, a Wireless Fidelity (Wi-Fi) device, a legacy radio device, and a proprietary network device.

In a third example of the system, optionally including one or both of the first and second examples, network traffic to the trusted core is communicated to the trusted core at least in part over the satellite backhaul.

In a fourth example of the system, optionally including one or more or each of the first through third examples, the integrated network includes at least one of a Macro cell transport, a Micro Cell transport, a Multi-access Edge Compute (MEC) transport, a 5G roaming transport, a RAN sharing transport, a 5G Sidelink transport or an Integrated Access and Backhaul (IAB) transport.

In a fifth example of the system, optionally including one or more or each of the first through fourth examples, the system further includes: an Open RAN (O-RAN) framework to split the cellular RAN to distribute functions between Radio Units (RUs), Distributed Units (DUs), and Centralized Units (CUs).

In a sixth example of the system, optionally including one or more or each of the first through fifth examples, the O-RAN framework includes at least one of a 5G New Radio (NR) air interface, a 5G Core network architecture, a 5G network slicer, an O-RAN Alliance specification, an O-RAN Software Community (OSC) implementation, or an O-RAN compliant RAN architecture.

In a seventh example of the system, optionally including one or more or each of the first through sixth examples, the trusted core manages a spectrum allocation of the satellite backhaul and the terrestrial backhaul.

In an eighth example of the system, optionally including one or more or each of the first through seventh examples, the trusted core includes a trusted federated 5G core.

Global connectivity using integrated space and territorial technologies promises enhanced operational capabilities for defense sectors, for mission-critical applications and multi-national organizations. The present teachings disclose an amalgamation of terrestrial and space-based networks through 5G technologies, offering a resilient, secure, and interoperable communication infrastructure to support a broad spectrum of applications anywhere in the world.

Additional features will be set forth in the description that follows, and in part will be apparent from the description, or may be learned by practice of what is described.

### BRIEF DESCRIPTION OF DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1 illustrates an integrated space and terrestrial network based on a trusted core according to various embodiments.

FIG. 2 illustrates a use case from training to mission operations in multiple locations with device portability according to various embodiments.

FIG. 3 illustrates an integrated network based on a unified space/terrestrial architecture to various embodiments.

FIG. 4A illustrates Integrated Access and Backhaul (IAB) according to various embodiments.

FIG. 4B illustrates a 5G Sidelink according to various embodiments.

FIG. 5 illustrates a 5G roaming and RAN sharing according to various embodiments.

FIG. 6A, FIG. 6B and FIG. 6C illustrate 5G Core placement options for an integrated network according to various embodiments.

FIG. 7 illustrates a functional split for 5G RAN using O-RAN Framework according to various embodiments.

FIG. 8 illustrates a method for integrating a satellite and terrestrial backhaul into an integrated network according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Embodiments are discussed in detail below. While specific implementations are discussed, this is done for illustration purposes only. A person skilled in the relevant art will recognize that other components and configurations may be used without parting from the spirit and scope of the subject matter of this disclosure.

The terminology used herein is for describing embodiments only and is not intended to be limiting of the present disclosure. As used herein, the singular forms "a," "an" and "the" are intended to include the plural forms as well, unless the context clearly indicates otherwise. Furthermore, the use of the terms "a," "an," etc. does not denote a limitation of quantity but rather denotes the presence of at least one of the referenced items. The use of the terms "first," "second," and the like does not imply any order, but they are included to either identify individual elements or to distinguish one element from another. It will be further understood that the terms "comprises" and/or "comprising", or "includes" and/or "including" when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

### I.Introduction

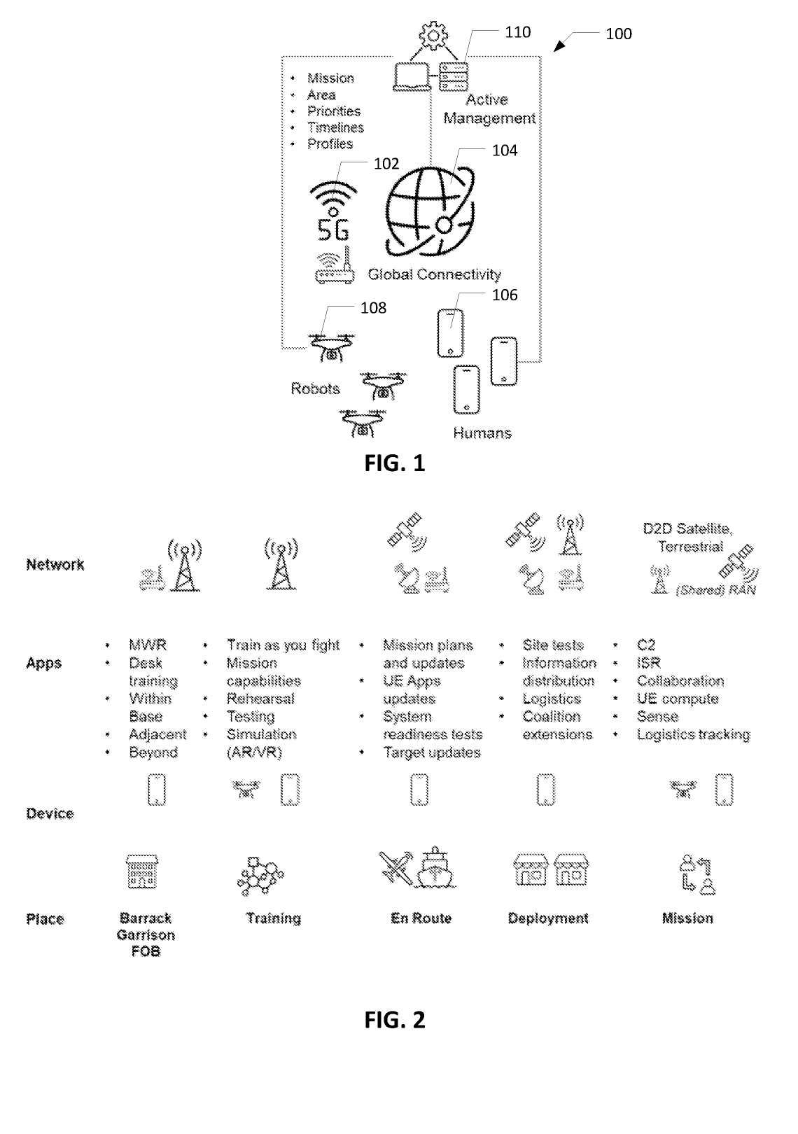

FIG. 1 illustrates an integrated space and terrestrial network based on a trusted according to various embodiments.

The need for robust and flexible global connectivity solutions has become increasingly apparent in today's dynamic operational environments. Organizations, whether military or civilian, require a communication framework that ensures high security, coverage, and availability, especially in remote or contested environments. In an integrated network 100, a convergence of cellular technology with satellite communications presents a transformative approach to achieving ubiquitous coverage and seamless connectivity, leveraging the best attributes of both terrestrial networks (TNs) 102 and non-terrestrial networks (NTNs) 104.

In the integrated network 100, COTS UE 106 is a cornerstone enabling standardization and interoperability across different platforms and international borders. The adoption of O-RAN enhances this integration, offering flexibility and scalability that can adhere to rigorous security standards for mission-critical operations and a robust supply chain.

The architecture includes TN 102 and NTN 104 components and integrates terrestrial cellular capabilities with existing broadband and future NTN satellite constellations. This approach addresses industries where reliable and secure communication networks are used without any location constraint, such as military, mining, energy, infrastructure maintenance, and large-scale event management. End user devices or COTS UE 106 can be used by both humans and robotic devices such as Unmanned Aerial Vehicles (UAVs) 108, land drones, sea drones or the like.

The present teachings disclose deployment of an integrated space and terrestrial network using a trusted, and federated, trusted core (not shown) operating seamlessly with satellite backhaul and terrestrial backhaul/fronthaul to active manage the integrated network 100 to ensure continuous service across diverse network deployments. The design addresses minimizing latency, maximizing throughput, and ensuring fault tolerance. Furthermore, the teachings explore the use of advanced cellular features such as Integrated Access and Backhaul (IAB) and Sidelink. The cellular features provide additional flexibility, coverage, and network resilience. These features provide multi-hop connectivity that can dynamically adapt to the changing operational needs, for example, when conventional infrastructure is lacking.

The present teachings include: (1) use of a common trusted Core (for example, a 5G core) for device authentication across diverse transports, (2) unification across broadband, space direct-to-device, terrestrial cellular networks, legacy and proprietary networks (such as SDN), (3) use of same applications across training and mission with device portability across locations, (4) use of SIM or PKI based authentication to accommodate cost-effective Wi-Fi devices in the framework, (5) use of an IP and cellular adapter to integrate legacy radios and other networks, (6) use of both edge and centralized management functions to benefit from globally optimized policies and autonomous edge orchestration, (7) continue to benefit from standards-based enhancements in Wi-Fi, O-RAN and cellular communications such as Wi-Fi 7 and 5G RAN sharing, IAB, and Sidelink, (8) leverage end-to-end and segment-wide slicing for QoS and data protection, and (9) enable the use of innovative networked applications for surveillance, command/control, and information fusion with AI/ML supported with edge compute and secure global network.

### II.UE Portability for Missions

FIG. 2 illustrates a use case from training to mission operations in multiple locations with device portability according to various embodiments.

The integration of cellular technologies, for example, in defense and first response applications, facilitates a seamless transition of UE from barracks to tactical mission environments. The integration ensures that connectivity and applications remain consistently available across all phases of an operation. UE supports personnel from preparation to active deployment, similar to commercial and consumer use while traveling. Both staff and robotic devices (such as drones) can utilize this 5G/6G-based connectivity.

Barracks and Training Facilities: Within the barracks, 5G/6G -enabled UE serves as a tool for training and readiness. Trainees use these devices to access training modules, participate in virtual simulations, and manage daily administrative tasks. The high-speed connectivity provided by 5G/6G ensures that training content, including multimedia and interactive Augmented Reality (AR)/Virtual Reality (VR) simulations, is delivered without latency, enhancing the learning experience and operational preparedness.

Transit and Deployment: As personnel transition from garrisons to deployment areas, the role of UE shifts towards more operational and strategic functions. During transit, staff rely on their devices for real-time updates, navigation, and communication with command centers. The robustness of 5G/6G connectivity allows for uninterrupted access to logistics information, mission briefings, and situational awareness data, ensuring that troops are informed and prepared as they move towards their operational objectives.

Tactical Mission Environments: In the field, UE becomes a lifeline for soldiers, providing capabilities such as command and control as well as intelligence, surveillance, and reconnaissance (ISR). Devices are used to coordinate movements, gather intelligence, and maintain communication with other units and command structures. The ability of 5G/6G to support high data rates and low latency communications is vital in these scenarios, where rapid data exchange and decision-making are crucial.

Multi-Domain Operations: Furthermore, a 5G/6G UE supports multi-domain operations by enabling familiar user devices to communicate across different sub-organizations and with coalition partners. This interoperability is essential for joint operations where coordination and data sharing between air, land, sea, and cyber forces are necessary to achieve mission objectives.

Enhanced Security and Management: Throughout these phases, the security and management of UE are maintained through advanced network management systems and Third-Generation Partnership Project (3GPP) security protocols for UE authentication with a trusted 5G/6G Core. Encryption, secure access, and continuous monitoring protect sensitive information against threats, while network management ensures that connectivity is optimized according to the operational needs and environmental conditions.

UE deployment from barracks to tactical missions underscores the transformative impact of 5G/6G technologies in enhancing the operational capabilities and readiness of defense personnel and first responders across various stages of their duties. The use cases highlight the adaptability, security, and efficiency of 5G/6G networks in supporting complex and dynamic operations across multiple locations.

### III.Architectural Objectives and DESIGN Approach

The integrated network architecture uses 5G/6G technologies for mission-critical applications to ensure secure, resilient, and high-performance global connectivity. For example, mission-critical operations, whether conducted by military forces or multinational organizations, operate with seamless global connectivity across a variety of operational environments and are flexible enough to adapt to evolving technological landscapes. The integration of COTS UE, for cost and familiarity and secure connectivity solutions, is pivotal.

Use of COTS UE: COTS 5G/6G and Wi-Fi enabled UEs enhance operational flexibility and reduce costs while meeting global standards for interoperability and security. By utilizing available commercial technology, organizations can leverage rapid advancements in telecommunications without experiencing delays associated with bespoke government equipment. This accelerates deployment and ensures that the latest 5G/6G device enhancements, fueled with large commercial investments, are integrated into the operational framework.

Secure Connectivity at All Locations: Ensuring secure and reliable connectivity across all operational phases—office/barracks, training, transit, deployment, mission, and morale, welfare, and recreation (MWR) activities—is essential. Each environment poses unique challenges and requirements, from the need for highly secure communications during missions to more open and accessible networks during peacetime or in garrison settings.

Pre-installed and Approved Apps: The use of pre-installed applications tailored for specific operational needs, such as ISR, Command and Control (C2), and logistics, enhance operational effectiveness. These applications work seamlessly across the 5G/6G and Wi-Fi networks, providing essential services and information flow irrespective of the user's location.

Compute/Storage at UE, Site, and Cloud: Integrating computing and storage capabilities directly on the UE, at local sites, and in the cloud allows for a distributed but cohesive data management strategy. This ensures that data is accessible when needed and securely stored, whether on-device, on-premises, or in a cloud environment for demanding applications like Augmented Reality/Virtual Reality (AR/VR).

### A.Global Connectivity with Commercial Services

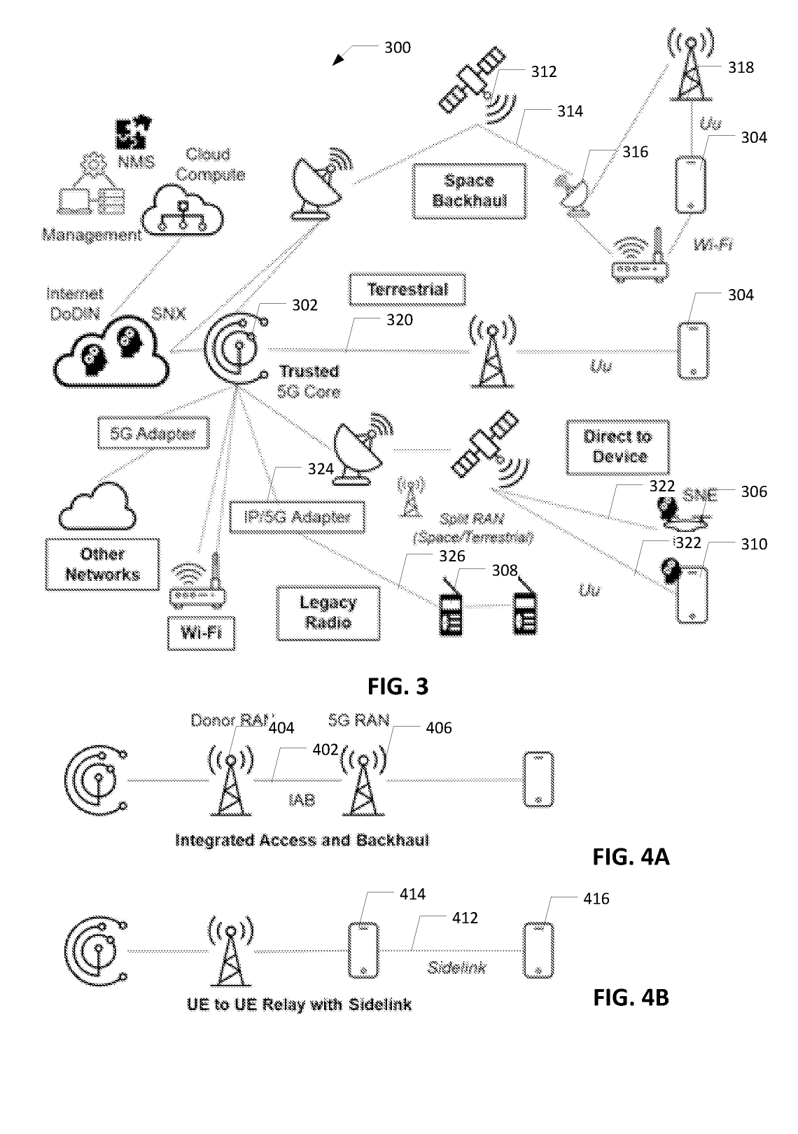

The backbone of global connectivity includes both terrestrial (for example, fiber), space and NTN elements to ensure wide coverage and high reliability with commercial technologies. The use of Geostationary Earth Orbit (GEO), Medium Earth Orbit (MEO), and Low Earth Orbit (LEO) satellites enhances global coverage, as shown in FIG. 3, particularly in areas where terrestrial infrastructure is not feasible. Each type of orbit offers distinct advantages, from the wide coverage area of GEO satellites to the reduced latency of LEO systems. Similarly, commercial 5G/6G networks can be used. The system benefits from the extensive infrastructure in-place around the world. This integration ensures that users can maintain high-speed connectivity as they move across different regions and networks.

### B.Emerging Satellite D2D

D2D satellite systems enable satellites to communicate directly with standard mobile devices, eliminating the need for specialized satellite phones or Very Small Aperture Terminals (VSATs).

### C.3GPP 5G, O-RAN, and Wi-Fi Standards

Adherence to the latest standards in mobile technology, such as those developed by the 3GPP and O-RAN, ensures that the network is both forward-compatible and interoperable with devices and networks globally. 3GPP has introduced NTN to extend the coverage of 5G networks and leverages the O-RAN modular approach, with components that are sourced from reliable sources, for implementing RAN over satellite links (vs towers).

### D.Security for Mission-Critical Communications

Securing mission-critical communications involves implementing multi-layered security protocols to protect data integrity, confidentiality, and availability across all touchpoints of the network.

Confidentiality, Availability, and Integrity for the UE’s user and network: These three pillars of information security are crucial for protecting the data that is transmitted across the network and the devices that are accessing it.

Zero Trust Architecture (ZTA): Implementing ZTA ensures that all network transactions are authenticated, authorized, and continuously validated for security compliance before and during an active session, regardless of the network’s endpoint.

Active Management: Provisioning, Performance, Faults, and Security Active management of network resources (across satellite, terrestrial, Core, RAN) allows for real-time monitoring and adjustment of network performance, rapid response to faults, proactive security measures, and efficient provisioning of network services.

Layered Virtual Private Networks (VPNs): For Traffic and Control Data Segregation: Using VPNs to segment control and traffic data enhances security by ensuring that sensitive information is isolated and transmitted securely, even over public networks.

### IV.Architectural Building Blocks

The deployment of integrated networks for mission-critical applications involves several foundational components, or architectural building blocks, that ensure the resilience, interoperability, and scalability of the network.

### A.Space Networks (GEO, MEO, LEO)

Gateway and UTs: Gateways serve as the interface points between the terrestrial networks and broadband satellite systems. UTs are deployed on the ground, in the air, or at sea, facilitating seamless communication across network boundaries. The integration of GEO, MEO, and LEO satellites ensures comprehensive coverage and diversified connectivity options, catering to different latency and bandwidth requirements. They typically provide 5G backhaul.

Satellites (Bent-Pipe or Processed): Satellites can be configured in 'bent-pipe' or digitally processed architectures. Bent-pipe satellites simply relay signals without modification, whereas digitally processed satellites can handle on-board data routing, enhancing efficiency and reducing the load on ground infrastructure. This flexibility is crucial for managing the varied demands of mission-critical communications.

Inter-Satellite Links: These links connect satellites in orbit, allowing for a mesh network in space that significantly improves data transfer speeds and network resilience. By facilitating direct satellite-to-satellite communication, inter-satellite links minimize the dependency on ground stations and enhance the global reach and performance of the network and UE.

### B.Terrestrial 5G/6G and Wi-Fi

5G/6G Core: The 5G/6G Core network plays a pivotal role in managing authentication, connectivity, network services, and roaming for 5G/6G devices. It acts as the backbone for network operations, supporting high data throughput and low latency communications. In scenarios where the primary core is unavailable, backup core functions ensure the continuity and reliability of network services. Global coverage may use a federated approach to the trusted Core, allowing for unified management and seamless service continuity across all transports around the world. This setup ensures that 5G/6G data and control services can be offered coherently irrespective of the underlying transport medium, location enhancing the operational flexibility and efficiency of the unified network.

Cellular RAN: The 5G/6G RAN is essential for connecting user devices to the core network and includes base stations and radio nodes that are distributed across various geographic locations, providing radio air interface for UE. This component maintains robust mobile connectivity and adapts to varying network conditions. Traditionally, towers have hosted (parts of) RANs and with NTN, extended coverage becomes possible with the use of satellites.

### C.RAN Component Placement Options:

There are many options for RAN component placement. The Central Unit (CU), Distributed Unit (DU), and Radio Unit (RU) can be deployed in a variety of configurations across terrestrial and space-based platforms to best meet the service requirements and environmental constraints.

Terrestrial (Near UE): Locating RAN components near UE helps reduce latency and improve connection quality to UEs, particularly in dense urban areas

Terrestrial (Near Internet): Positioning RAN components close to internet backbones can enhance data throughput and leverage cloud efficiencies.

In Satellite (RAN or Parts Thereof): Embedding RAN capabilities within satellites offers direct access to the network services from space, reducing dependency on terrestrial infrastructure.

### D.Management Functions

Centralized management of Core and RAN components provides efficient operation, optimal resource allocation, and effective fault management across the network. This requires autonomous operation at the network edge using globally optimized policies and configuration provided a centralized function.

Smart Network Edge (SNE): The SNE enhances network resiliency by enabling autonomous decision-making at the edge of the network. This capability reduces latency and improves the reliability of mission-critical applications, especially in edge-dominated scenarios where multiple transports exist for a UE (e.g., Wi-Fi and 5G/6G).

Smart Network Exchange (SNX): The SNX acts as an aggregator for traffic from various network edges, optimizing data flow and enhancing network performance. This component plays a key role in ensuring that connectivity remains robust and responsive under varying network loads and conditions.

Network Management System (NMS): The NMS oversees all network operations, mission planning, traffic management, fault detection, security management, and performance monitoring. It provides the tools that are needed to maintain high levels of network performance and reliability, which is crucial for mission-critical operations where downtime can have significant repercussions.

### V.Unified Space-Terrestrial Architecture:

FIG. 3 illustrates an integrated network based on a unified space/terrestrial architecture to various embodiments.

A unified space-terrestrial architecture provides the integration of cellular technologies with satellite communication systems, creating an integrated network 300 that is seamless and resilient. The integrated network 300 is designed for continuous and secure connectivity across diverse operational environments, facilitated by the use of a trusted core 302 for authenticating UE, such as, mobile UE 304, drone 306, legacy UE (or radio) 308, D2D UE 310. The mobile UE 304 may connect to trusted core 302 either via a TN 320 or via a NTN 314 relayed by a satellite 312. This increases the operational range and flexibility of network services and strengthens the overall security of the integrated network 100.

UE Authentication: Either SIM cards or PKI certificates can be used in conjunction with a trusted Core to authenticate UE on the integrated network 100. This combination can provide a seamless and secure connectivity experience. The trusted core 302 supports a robust and flexible authentication framework that can incorporate different methods, including SIM, non-SIM, and certificate-based approaches. This flexibility is part of a 5G/6G system’s security features that supports a wide range of use cases, including IoT, enterprise solutions, and mobile broadband.

Diverse Transports with a Common Core: Space-backhaul or transport provided by NTN 314 is used for deploying cellular services in remote areas. It involves the placement of a satellite UT 316 near a cellular tower 318. TN 320 provides a terrestrial backhaul or transport. Satellite D2D transport 322 allows the use of COTS 5G UE without a local RAN or satellite UT. An IP/5G adapter 324 secures a legacy radio or transport 326 to communicate with a legacy UE 308.

Space 5G backhaul: Space 5G backhaul connects the RAN to the core network through satellite systems, including GEO, MEO, and LEO satellites. This connection extends the reach of terrestrial networks into remote and underserved areas, providing consistent and reliable service where traditional infrastructure is absent. Space 5G backhaul provides access to high-speed, high-capacity 5G services in even the most geographically isolated locations. This is beneficial for applications that require robust communication links, such as disaster response, remote operations, and tactical military engagements.

Satellite D2D: The D2D capability enables a standard COTS UE to connect directly to satellite networks. This allows for global coverage, ensuring that users have reliable connectivity regardless of their location.

Wi-Fi: The standards such as Passpoint and Open Roaming allow automated authentication of Wi-Fi users with a trusted Core and SIM card or PKI certificates. Passpoint, developed by the Wi-Fi Alliance, allows users to seamlessly connect to Wi-Fi networks without the need for manual login and authentication procedures. A standardized protocol automates the process of network discovery, selection, and access. This technology provides mobile users, who move through various Wi-Fi hotspots and 5G/6G networks, a secure and effortless connectivity experience. Open Roaming extends these capabilities by allowing devices to switch at scale between Wi-Fi and cellular networks operated by multiple organizations.

Legacy Radios and Other Networks: Utilizing a trusted Core to authenticate legacy radio systems, such as Land Mobile Radio (LMR) and those used by military and first responders, is a significant advancement in secure and reliable communication. These legacy systems are critical for public safety and defense operations, where immediate and secure communication is imperative. Integrating these radios with a trusted Core through IP and 5G/6G Adapters enhances their security protocols and enterprise-wide connectivity while maintaining their robustness. This integration enables a unified authentication and strong encryption and identity verification. As a result, first responders and military personnel can benefit from a modernized, secure network that supports both new and existing communication tools, ensuring seamless operations across various scenarios.

This approach, also applicable to other networks, bolsters security and improves interoperability between old, bespoke (such as legacy and next generation government networks such as SDN) and new communication infrastructures, providing a cohesive platform for critical communications.

### A.5G/6G Technologies and Management

5G/6G Terrestrial Network with O-RAN: On the ground, the architecture incorporates O-RAN innovations, which enhances the flexibility and scalability of 5G/6G networks. O-RAN facilitates a more open and interoperable network ecosystem—allowing a diverse array of vendors and equipment to coexist and function seamlessly around the world.

Roaming and RAN Sharing: The terrestrial segment of supports advanced roaming and RAN sharing capabilities for maintaining service continuity for users as they move between different network environments. This feature in the integrated network ensures that users can transition between satellite and terrestrial networks without service interruptions. Roaming can expose UE credentials to the local Core and RAN sharing can mitigate this vulnerability.

Trusted Core Performance: The trusted core of the network hosts security functions and provides a secure environment for all network operations. This core is responsible for authenticating all UE, ensuring that only authorized devices gain access to the network which requires high availability and responsive operations of 5G/6G Core. This logically centralized authentication mechanism can be implemented as a federation of cooperating physical instances distributed at multiple locations.

Core Federation: The architecture supports the federation of 5G/6G Cores with multiple physical instances, allowing different network segments to share resources and capabilities securely. This federation enhances the overall flexibility and efficiency of the network, enabling it to adapt to various operational demands while providing the required security.

Active Management: Active management oversees provisioning, performance, fault management, and security across the integrated network. The integrated network may include satellite communication networks, 5G/6G networks, UE, and computing infrastructure. In some embodiments, management systems (including SNE, SNX, and NMS) ensure that the network operates efficiently and can dynamically respond to changes in network conditions or security threats. The integrated network employs advanced resiliency and security policies to actively protect against potential disruptions and cyber threats. These policies may be updated and enforced to align with the evolving security and operational requirements.

### VI.5G/6G Advanced Features

The evolution of 5G/6G technologies has introduced features such as IAB and RAN sharing to enhance the coverage and efficiency of network deployments.

### A.5G IAB

FIG. 4A illustrates an Integrated Access and Backhaul (IAB) according to various embodiments.

5G IAB 402 enables the use of the same spectrum resources for both user access and network backhaul. This dual functionality is particularly advantageous in environments where laying physical backhaul connections is too impractical or costly. 5G IAB 402 supports deployment of 5G networks by allowing a new node 404 to connect wirelessly to the nearest backhaul-equipped site 406, thereby extending the network's reach without the need for extensive ground infrastructure. Introduced in 3GPP Release 17, IAB is being enhanced in Release 18 and 19.

FIG. 4B illustrates a 5G Sidelink according to various embodiments.

Similar to an IAB, a Sidelink 412 provides multi-hop connectivity from a donor UE 414 to a donee UE 416.

Multi-Hop Connectivity: IAB facilitates multi-hop connectivity across RANs using the same spectrum, where data can be relayed wirelessly through multiple IAB nodes before reaching the Core. This capability is vital for extending coverage to remote or temporary deployment areas, such as disaster recovery sites or tactical field operations. By enabling data to hop between nodes, IAB enhances the resilience and flexibility of the network, allowing it to maintain connectivity even if some links are disrupted.

Support for Dynamic Environments: The flexibility of IAB and Sidelink makes them well-suited for dynamic environments where network demands can change rapidly. This is particularly relevant in military operations, emergency response events, and other scenarios requiring quick scalability and adaptability. A RAN Intelligence Controller (RIC) within the O-RAN framework provides an agile function for dynamic IAB link adjustments.

### B.5G RAN Sharing

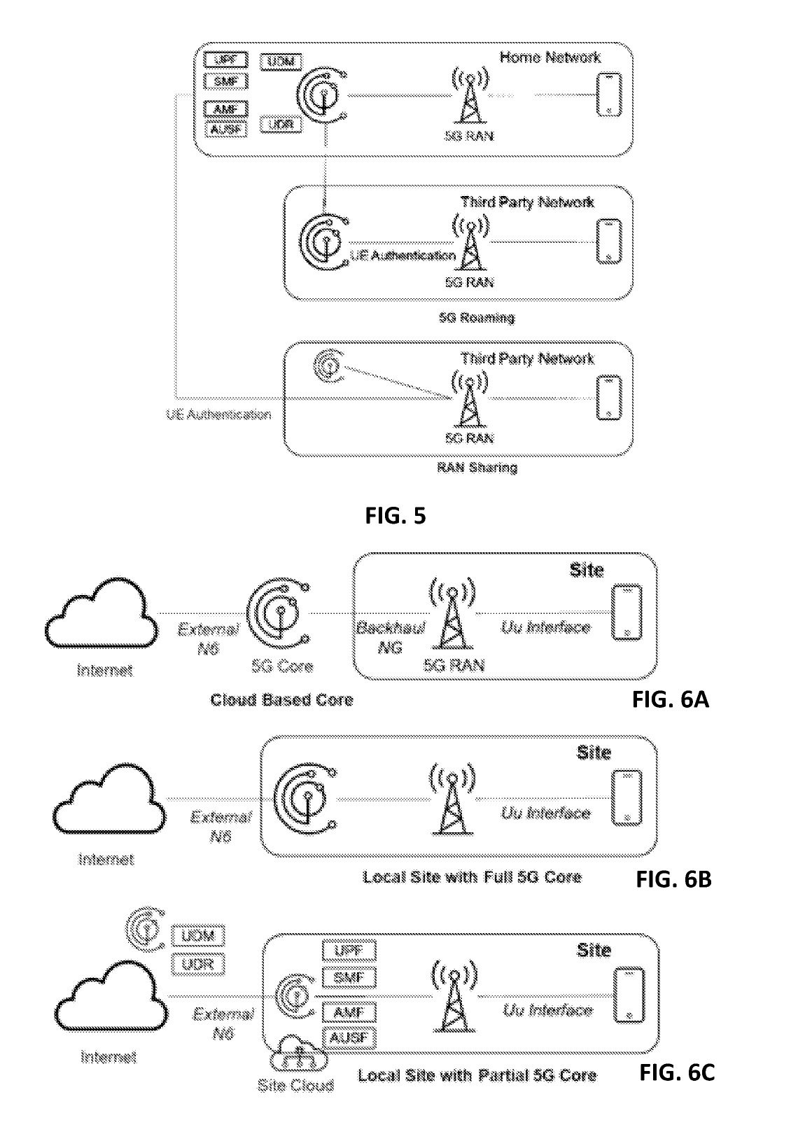

FIG. 5 illustrates a 5G roaming and RAN sharing according to various embodiments.

RAN sharing in 5G networks allows multiple operators to utilize the same network infrastructure for cost efficiency and extending network coverage. RAN sharing offers resource optimization and operational flexibility to enhance the service capabilities and economic viability of 5G deployments.

RAN sharing enables different network operators to share spectrum and physical infrastructure such as antennas, base stations, and other network hardware. This collaboration reduces the duplication of network assets and lowers capital and operational expenditures, as well as accelerates the deployment of new technologies across broader areas without compromising UE security credentials. By pooling resources, operators can cover larger geographic regions (including rural and underserved areas), and other countries more efficiently and cost-effectively.

The shared use of RAN components improves network resilience and service availability, as operators can leverage a collective pool of infrastructure to ensure connectivity even in the event of individual component failures. This redundancy is particularly beneficial in maintaining service quality, network uptime, user satisfaction, and network reliability.

RAN sharing optimizes the use of physical infrastructure and enhances the efficiency of spectrum utilization. This is increasingly important as the demand for wireless bandwidth continues to grow. Efficient spectrum use facilitated by RAN sharing helps in meeting the regulatory requirements and managing the limited available spectrum more effectively. While RAN sharing offers numerous benefits, it also requires careful regulatory considerations to ensure fair competition and prevent monopolistic practices. Operators must navigate these regulatory landscapes to implement RAN sharing effectively, fostering a cooperative environment that benefits all stakeholders without stifling competition.

RAN sharing represents a transformative strategy in the deployment of 5G networks, addressing economic and technical challenges while enhancing network capacity and coverage, and protecting UE user and network data. This approach supports the rapid expansion of 5G services and promotes a sustainable model for future telecommunications infrastructure development, benefiting operators, consumers, and regulators alike.

The use of 5G IAB in concert with RAN sharing into network architectures represents a unique advancement offering security, increased flexibility, cost efficiency, and enhanced coverage. These features are particularly beneficial in supporting mission-critical applications and expanding network services to underserved or challenging environments, ensuring that reliable and high-quality connectivity is maintained at all times.

### C.5G/6G Core Placement Options

FIG. 6A, FIG. 6B and FIG. 6C illustrate 5G/6G Core placement options for an integrated network according to various embodiments.

The placement of the 5G/6G Core caters to different network demands, balancing performance, operational efficiency, and security. The choice between cloud-based (FIG. 6A), full on-site (FIG. 6B), and partial on-site (FIG. 6C) core placements depends on the specific network requirements, including cost considerations, performance needs, and security constraints. Each option offers distinct advantages and challenges, allowing operators to tailor their core network architecture to best fit their operational goals and service obligations. As 5G/6G networks continue to evolve, these core placement strategies will play a crucial role in shaping the effectiveness and efficiency of telecommunications infrastructure across various applications and industries.

Cloud-Based Core: Deploying the 5G/6G Core in a cloud environment offers significant operational benefits, including scalability, flexibility, and reduced capital expenditure. Cloud-based cores can dynamically allocate computing and networking resources based on real-time demand, providing a cost-effective solution that adjusts to varying loads without the need for physical infrastructure expansion. While a cloud-based Core offers many operational and cost advantages, it also introduces challenges related to data latency and privacy. Since user data is handled and stored in cloud data centers, potentially far from the end-user, there can be increased latency and concerns over data security. Robust security measures, and possibly regional data handling, may be used to comply with data protection regulations, which may become onerous when government and commercial operations cannot be separated.

Full 5G/6G Core On-Site: Placing a full 5G/6G Core on-site provides operators with complete control over the network, enhancing security while reducing latency for local users. This arrangement is ideal for environments that require high security and low response times, such as military facilities or critical infrastructure. A full on-site core incurs increased cost and complexity of deployment, maintenance, significant upfront investment in infrastructure and ongoing expenses in terms of operation and maintenance. NMS helps mitigate some of these operational costs.

Partial 5G/6G Core On-Site: A partial on-site core offers a balance between the cloud-based and full on-site models. Core functions, such as the User Plane Function (UPF), might be hosted on-site, while other control plane components (like the Access and Mobility Management Function (AMF) and Session Management Function (SMF)) might be hosted in the cloud. This reduces latency for data processing by managing it locally while still leveraging the cloud for less sensitive operations. It offers flexibility in managing data traffic and can be a cost-effective solution for network operators without full on-site deployment. Partial core placement allows for enhanced security and performance where it matters most, providing a practical compromise for operators who need to prioritize key aspects of their network operations without the extensive costs associated with a full on-site core.

### D.Split RAN for Satellite D2D

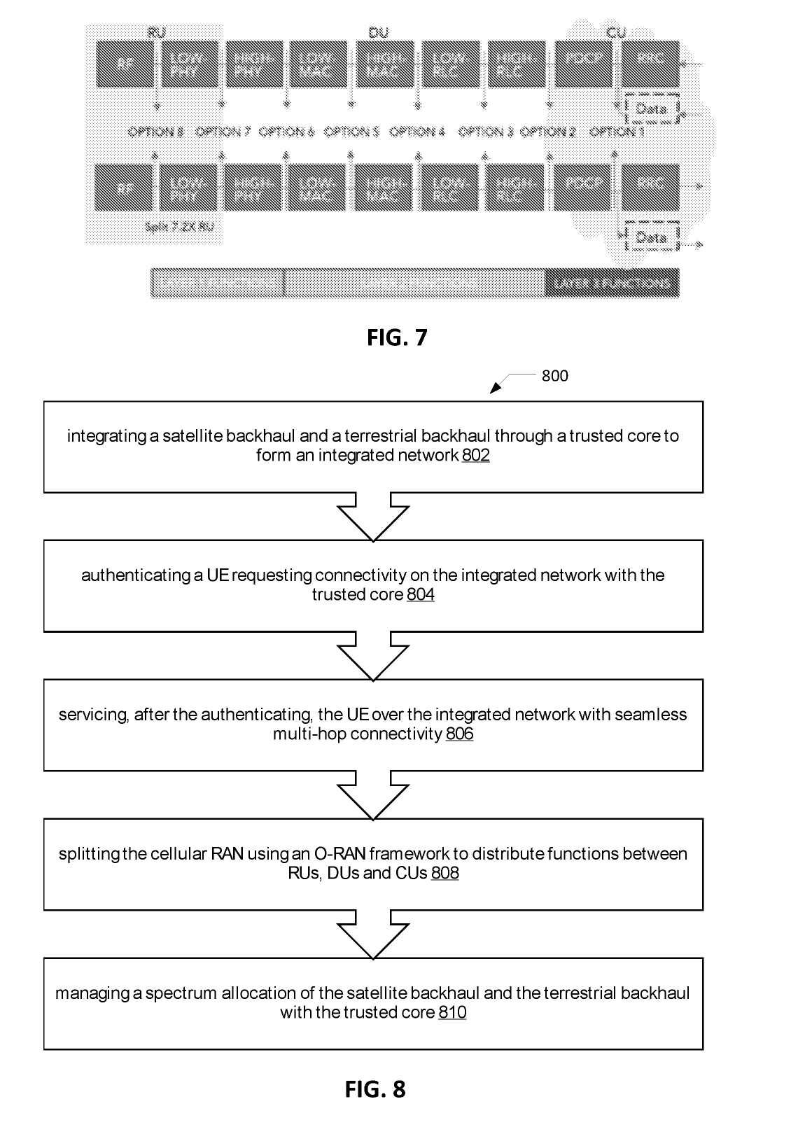

FIG. 7 illustrates a functional split for 5G/6G RAN using O-RAN Framework according to various embodiments.

Split RAN architecture plays a key role in the deployment of flexible 5G/6G networks, particularly when integrating satellite communication elements and considering the onboard processing requirements. The splitting of RAN functions allows for enhanced network management, scalability, and cost efficiency, adapting to the unique demands of space-based and terrestrial network elements.

Appropriate placement of the RAN functional units—CU, DU, and RU—enables optimization of infrastructure investments by aligning network deployments with specific geographic and service demand characteristics. This flexibility, when integrating satellite communications, balances the cost implications of transmitting data to and from space necessitate the efficient use of bandwidth and processing capabilities. Satellite payload hardware and power are premium resources and its efficient utilization is critical. Split RAN architecture allows for intelligent data routing and processing, which minimizes unnecessary data transmission through expensive satellite links, thereby reducing operational costs.

There are multiple options for satellite placement of RAN components, within the framework of O-RAN.

Onboard Processing: By processing data onboard satellites (DU functionalities), operators can reduce the amount of data that needs backhaul to Earth, which significantly decreases latency and enhances user experience, especially in remote areas. This approach requires robust onboard processing capabilities and satellite power but offers considerable long-term savings and performance improvements.

CU: Ideally positioned on the ground near a satellite gateway or in a cloud environment, the CU manages the control plane functionalities, benefiting from robust computational resources without the stringent size and power constraints of a space-based platform.

DU: For satellite networks, splitting a DU by placing some DU functionalities onboard can dramatically enhance network responsiveness and efficiency. Split processing leverages the high processing power that is available on modern satellites, allowing for real-time data handling and immediate response without the latency introduced by ground communication. For example, FIG. 7 illustrates a 7.2x split of a 5G RAN using the O-RAN framework keeps high PHY layer processing on the ground while low PHY layer processing is in the satellite connected with an eCPRI interface.

RU: RUs performing RF transmit and receive function, include advancements such as beam forming antennas with adaptive power and directivity, can now be placed on the satellite interfacing directly with user devices. Their placement ensures optimal signal transmission and reception, directly impacting network coverage and quality of service by dynamically adjusting antenna gain, spectrum usage, and power.

The decision to split RAN functions across terrestrial and satellite segments involves a delicate balance between performance requirements and operational costs. While onboard satellite processing offers significant advantages in terms of latency and bandwidth usage, it requires substantial upfront investment in satellite technology and infrastructure. Conversely, ground-based processing benefits from existing infrastructure but may incur higher long-term operational costs due to increased satellite bandwidth usage.

### VII.Unified Space/Terrestrial Implementation

The integrated space/terrestrial architecture includes specific technological components and where each technology stands in terms of development and deployment. Some areas like terrestrial 5G are highly mature, D2D satellite communication is developing, while management function fall somewhere in the middle.

Space backhaul connects the 5G/6G Core with the RAN via satellite links, which include standards-based integration and the use of GEO, MEO, and LEO satellites. This approach allows for extending 5G/6G services to remote and hard-to-reach areas without the need for extensive terrestrial infrastructure. Space backhaul provides reliable and expansive coverage where terrestrial backhaul links are not feasible or economically viable. Space backhaul faces challenges, such as the need for satellite UTs to provide local RANs for 5G/6G operations and the limited coverage of Wi-Fi services. The maturity of GEO-based backhauls is well-established, while LEO technologies are rapidly advancing and being deployed offering lower latency solutions.

5G Terrestrial uses globally interoperable terrestrial networks that utilize various COTS UEs, with adherence to the 5G standards for QoS and security. Terrestrial 5G networks offer robustness and flexibility with the use of O-RAN, facilitating network global networking in most of the populated and affluent regions. However, 5G terrestrial incurs high costs associated with expanding coverage in sparsely populated areas and the challenges in supporting mobile platforms across vast land masses and the oceans. The terrestrial 5G networks are at a high maturity level with established 3GPP standards and ongoing expansions in network capabilities and coverage.

Satellite D2D capabilities allow COTS 5G UEs to directly communicate with satellites, bypassing terrestrial base stations. One advantage is truly global connectivity, as it enables devices anywhere to connect without the need for local network infrastructure. The gaps include spectrum challenges, coordination with multiple MNOs and local regulatory regimes, and limited capacity, which could hinder widespread adoption and performance. Satellite D2D is still in the early stages of deployment.

COTS software can automate management and edge orchestration of multiple transport layers and manage global policies including 5G, satellite networks, Wi-Fi and 5G devices. The integration of management functions across platforms enhances operational efficiency and ensures consistent policy and security management across the network. There are still challenges related to integrating stove-piped space and 5G cellular management systems. SNE and NMS integrated for private 5G provide a good starting point.

RAN sharing and IAB optimize network efficiency and coverage. The integration of satellite and terrestrial network elements with a trusted Core into a single cohesive network allows for seamless connectivity across challenging and remote environments to serve a broader range of applications. 5G O-RAN technology facilitates greater flexibility and vendor neutrality to promote competition and innovation within the industry. A trusted core for secure UE authentication across both network types advances robust security standards, for example, for mission-critical operations.

The present teachings address the gaps in spectrum challenges and capacity limitations. In some embodiments, expanding 5G/6G RAN Sharing and IAB implementations enhances network resilience and coverage, especially in underserved areas. In other embodiments, continuous integration and standardization harmonizes the interfaces and protocols between the different network elements to ensure interoperability and security. A continuous feedback and adaptation based on operational data with the unified management refines and optimizes network performance. In some embodiments, security enhancements to network endpoints ensure the integrity of data transmission across both terrestrial and space segments with additional secure overlays (tunnels) using advanced encryption. The integration of space and terrestrial technologies to create a unified architecture addresses connectivity challenges and sets the stage for future advancements.

FIG. 8 illustrates a method for integrating a satellite and terrestrial backhaul into an integrated network according to various embodiments.

A method 800 for integrating a satellite and terrestrial backhaul into an integrated network may include operation 802 for integrating a satellite backhaul and a terrestrial backhaul through a trusted core to form an integrated network. Method 800 may include operation 804 for authenticating a UE requesting connectivity on the integrated network with the trusted core. Method 800 may include operation 806 for servicing, after the authenticating, the UE over the integrated network with seamless multi-hop connectivity. Method 800 may include operation 808 for splitting the cellular RAN using an O-RAN framework to distribute functions between RUs, DUs and CUs. Method 800 may include operation 810 for managing a spectrum allocation of the satellite backhaul and the terrestrial backhaul with the trusted core.

Although the subject matter has been described in language specific to structural features and/or methodological acts, it is to be understood that the subject matter in the appended claims is not necessarily limited to the specific features or acts described above. Rather, the specific features and acts described above are disclosed as example forms of implementing the claims. Other configurations of the embodiments described are part of the scope of this disclosure. Further, implementations consistent with the subject matter of this disclosure may have more or fewer acts than as described or may implement acts in a different order than as shown. Accordingly, the appended claims and their legal equivalents should only define the invention, rather than any specific examples given.

What is claimed is:

1. A method for integrating, comprising:
integrating a satellite backhaul and a terrestrial backhaul through a trusted core to form an integrated network;
authenticating a User Equipment (UE) requesting connectivity on the integrated network with the trusted core; and
servicing, after the authenticating, the UE over the integrated network with seamless multi-hop connectivity,
wherein the terrestrial backhaul comprises a cellular Radio Access Network (RAN).

2. The method of claim 1, wherein the authenticating authenticates the UE based on a Public Key Infrastructure (PKI) or a Subscriber Identity Module (SIM) received from the UE.

3. The method of claim 1, wherein the UE comprises one or more of an unlicensed spectrum device, a Wireless Fidelity (Wi-Fi) device, a legacy radio device, and a proprietary network device.

4. The method of claim 1, wherein the UE comprises a Third Generation Partnership Project (3GPP) Fifth Generation (5G) technology compliant UE and the trusted core comprises a 5G compliant core.

5. The method of claim 1, wherein network traffic for the authenticating is communicated to the trusted core at least in part over the satellite backhaul.

6. The method of claim 1, wherein the servicing hands-off between the satellite backhaul and the terrestrial backhaul without interrupting connectivity of the UE.

7. The method of claim 1, wherein the integrated network comprises at least one of a Macro cell transport, a Micro Cell transport, a Multi-access Edge Compute (MEC) transport, a 5G roaming transport, a RAN sharing transport, a 5G Sidelink transport or an Integrated Access and Backhaul (IAB) transport.

8. The method of claim 1, further comprising splitting the cellular RAN using an Open RAN (O-RAN) framework to distribute functions between Radio Units (RUs), Distributed Units (DUs), and Centralized Units (CUs).

9. The method of claim 8, wherein the O-RAN framework comprises at least one of a 5G New Radio (NR) air interface, a 5G Core network architecture, a 5G network slicer, an O-RAN Alliance specification, an O-RAN Software Community (OSC) implementation, or an O-RAN compliant RAN architecture.

10. The method of claim 1, further comprising managing a spectrum allocation of the satellite backhaul and the terrestrial backhaul with the trusted core.

11. The method of claim 1, wherein the trusted core comprises a trusted federated 5G core.

12. A system comprising:
a trusted core to form an integrated network by integrating a satellite backhaul and a terrestrial backhaul;
a User Equipment (UE) to be authenticated and to request connectivity on the integrated network with the trusted core; and
wherein the integrated network services the UE with seamless multi-hop connectivity, after the UE has been authenticated, and wherein the terrestrial backhaul comprises a cellular Radio Access Network (RAN).

13. The system of claim 12, wherein the trusted core authenticates the UE based on a Public Key Infrastructure (PKI) or a Subscriber Identity Module (SIM) received from the UE.

14. The system of claim 12, wherein the UE comprises one or more of an unlicensed spectrum device, a Wireless Fidelity (Wi-Fi) device, a legacy radio device, and a proprietary network device.

15. The system of claim 12, wherein network traffic to the trusted core is communicated to the trusted core at least in part over the satellite backhaul.

16. The system of claim 12, wherein the integrated network comprises at least one of a Macro cell transport, a Micro Cell transport, a Multi-access Edge Compute (MEC) transport, a 5G roaming transport, a RAN sharing transport, a 5G Sidelink transport or an Integrated Access and Backhaul (IAB) transport.

17. The system of claim 12, further comprising an Open RAN (O-RAN) framework to split the cellular RAN to distribute functions between Radio Units (RUs), Distributed Units (DUs), and Centralized Units (CUs).

18. The system of claim 17, wherein the O-RAN framework comprises at least one of a 5G New Radio (NR) air interface, a 5G Core network architecture, a 5G network slicer, an O-RAN Alliance specification, an O-RAN Software Community (OSC) implementation, or an O-RAN compliant RAN architecture.

19. The system of claim 12, wherein the trusted core manages a spectrum allocation of the satellite backhaul and the terrestrial backhaul.

20. The system of claim 12, wherein the trusted core comprises a trusted federated 5G core.
